(19) United States
(12) Patent Application Publication
(10) Pub. No.: US 2024/0394517 A1
(43) Pub. Date: Nov. 28, 2024

(54) GENERATIVE ARTIFICIAL INTELLIGENCE (AI) ARCHITECTURE WITH DOMAIN OPTIMIZATION

(71) Applicant: Wells Fargo Bank, N.A., San Francisco, CA (US)

(72) Inventors: Ashish B. Kurani, Hillsborough, CA (US); Cleane Sakaguti, San Francisco, CA (US); Eileen Holcomb, San Francisco, CA (US); Shobha Duggirala, San Francisco, CA (US)

(73) Assignee: Wells Fargo Bank, N.A., San Francisco, CA (US)

(21) Appl. No.: 18/674,196

(22) Filed: May 24, 2024

Related U.S. Application Data
(60) Provisional application No. 63/469,280, filed on May 26, 2023.

(51) Int. Cl. G06N 3/0475

(52) U.S. Cl. CPC G06N 3/0475

(57) ABSTRACT

Aspects of this technical solution can identify, based on a query, an entity and an object corresponding to the entity, obtain, via an artificial intelligence (AI) model, an entity object that identifies one or more aspects extrinsic to the entity and linked with the entity, obtain, via the AI model, a condition object that identifies one or more aspects extrinsic to the object and the entity, generate, via the AI model, an action object that identifies an action metric, the AI model receiving as input the entity object and the condition object, and cause, in response to the query and based on the action metric, execution of a transaction including the object and the entity.

### CROSS-REFERENCE TO RELATED PATENT APPLICATIONS

This application claims the benefit of priority under 35 U.S.C. § 119 to U.S. Provisional Patent Application Ser. No. 63/469,280, filed May 26, 2023, which is incorporated by reference herein in its entirety and for all purposes.

### TECHNICAL FIELD

The present implementations relate generally to database systems, including but not limited to a generative artificial intelligence (AI) architecture with domain optimization.

### BACKGROUND

Various settings require access to information to make informed decisions. However, such actions often involve pulling duplicative or redundant data across multiple platforms, accessing each of such platforms independently, and compiling the data to generate the deliverable. By the time such a task can be performed manually, the commercial value of the data is largely mooted because the analysis no longer accurately reflects the conditions that the data is to describe. This leads to increased bandwidth occupancy as well as increased processing power requirements.

### SUMMARY

This technical solution is directed at least to an architecture to provide at least one output via a generative artificial intelligence (AI) model configured to operate on and recognize semantic and relational properties of domain-specific data and objects linked with the domain-specific data. Thus, a technical solution for generative AI architecture with domain optimization is provided according to various embodiments herein.

At least one aspect is directed to a system that can include one or more non-transitory memory devices and one or more processors coupled to the one or more memory devices. The system can identify, based on a query, an entity and an object corresponding to the entity. The system can obtain, via an artificial intelligence (AI) model, an entity object that identifies one or more aspects extrinsic to the entity and linked with the entity. The system can obtain, via the AI model, a condition object that identifies one or more aspects extrinsic to the object and the entity. The system can generate, via the AI model, an action object that identifies an action metric, the AI model receiving as input the entity object and the condition object. The system can cause, in response to the query and based on the action metric, execution of a transaction can include the object and the entity.

At least one aspect is directed to a method that can include identifying, based on a query, an entity and an object corresponding to the entity. The method can include obtaining, via an artificial intelligence (AI) model, an entity object that identifies one or more aspects extrinsic to the entity and linked with the entity. The method can include obtaining, via the AI model, a condition object that identifies one or more aspects extrinsic to the object and the entity. The method can include generating, via the AI model, an action object that identifies an action metric, the AI model receiving as input the entity object and the condition object. The method can include causing, in response to the query and based on the action metric, execution of a transaction can include the object and the entity.

At least one aspect is directed to a system that can include least one processing circuit comprising at least one memory coupled to at least one processor. The system can identify, based on a query, first data having an authenticity property and can include one or more first transaction records, the first transaction records identifying one or more actual transactions. The system can generate, via an artificial intelligence (AI) model, second data having the authenticity property and can include one or more second transaction records, the second transaction records corresponding to one or more synthetic transactions that have not been executed by the one or more entities.

At least one aspect is directed to a method that can include identifying, based on a query, first data having an authenticity property and can include one or more first transaction records, the one or more first transaction records identifying one or more actual transactions. The method can include generating, via an artificial intelligence (AI) model, second data having the authenticity property and can include one or more second transaction records, the one or more second transaction records corresponding to one or more synthetic transactions that have not been executed by the one or more entities.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with present implementations.

FIG. 2 depicts an example generative engine computing system, in accordance with present implementations.

FIG. 3 depicts an example method of operating a generative AI architecture with domain optimization, in accordance with present implementations.

FIG. 4 depicts an example method of operating a generative AI architecture with domain optimization, in accordance with present implementations.

FIG. 5 depicts an example method of operating a generative AI architecture with domain optimization, in accordance with present implementations.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

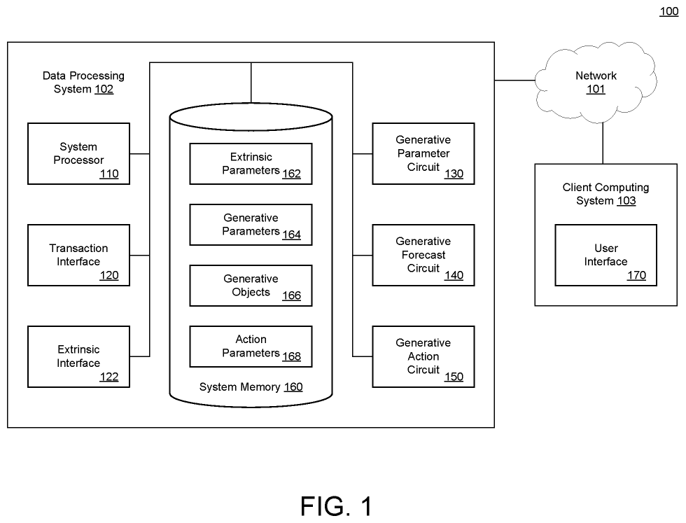

FIG. 1 depicts an example system, in accordance with present implementations. As illustrated by way of example in FIG. 1, an example system 100 can include at least one or more of a network 101, a data processing system 102, and a client computing system 103.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP Internet protocol suite can include application layer, transport layer, Internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or directly through an intermediate computing device or system. The data processing system 102 can include a virtual computing system, an operating system, and a communication bus to effect communication and processing. The data processing system 102 can include a system processor 110, a transaction interface 120, an extrinsic interface 122, a generative parameter circuit 130, a generative forecast circuit 140, and a generative action circuit 150.

For example, the data processing system 102 can be an institution computing system, such that the data processing system 102 and institution computing system are phrases that are used interchangeably herein. The institution computing system 102 is owned by, associated with, or otherwise operated by a provider institution (e.g., a bank or other financial institution) that maintains one or more accounts held by various customers (e.g., the customer associated with the customer device 103), such as demand deposit accounts, credit card accounts, receivables accounts, and so on. In some instances, the institution computing system, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the institution computing system may be or may include various other devices communicably coupled thereto, such as, for example, desktop or laptop computers (e.g., tablet computers), smartphones, wearable devices (e.g., smartwatches), and/or other suitable devices.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The transaction interface 120 can include a communication interface configured to receive and transmit data from a computing system of a financial institution, in a format compatible with the computing system of the financial institution. For example, the transaction interface 120 can communicate with the computing system of the financial institution by an application programming interface (“API”) configured to transmit data corresponding to a particular financial transaction, financial record, financial analysis, financial assessment, or any combination thereof, but is not limited thereto. Thus, the computing system of the financial institution can interface with the computing system of the financial institution to execute communication in accordance with one or more protocols of the financial institution integrated into a protocol of the transaction interface 120.

The extrinsic interface 122 can include a communication interface configured to receive and transmit data from a computing system distinct from a financial institution, in a format compatible with those computing systems. For example, the transaction interface 120 can communicate with various computing systems by an application programming interface (“API”) configured to transmit financial records, social media feed content or metadata, map content or metadata related to an individual or entity, photographic or 3D model data of real estate, public title information, court records, passport information, or any combination thereof. Thus, the computing system of the financial institution can interface with the computing system of the financial institution to execute communication in accordance with one or more protocols of the financial institution integrated into a protocol of the transaction interface 120.

The generative parameter circuit 130 can generate one or more parameters via one or more generative AI models. The parameters can correspond to input(s) provided to the generative AI model based on domain data. For example, the financial domain data can be distinct from or excluded from a training set applied to build or train the generative AI model. Thus, the generative parameter circuit 130 can operate on input data to generate parameters based on domain data. For example, the generative parameter circuit 130 can correspond at least partially in one or more of structure and operation to the system processor 110, or can include one or more processors or portions thereof configured to be compatible with a generative AI model configure to operate on domain data.

The generative forecast circuit 140 can generate output(s) via a generative AI model based on one or more parameters via a generative AI model. The parameters can correspond to input provided to the generative AI model based on domain data. For example, the financial domain data can be distinct from or excluded from a training set applied to build or train the generative AI model. Thus, the generative forecast circuit 140 can operate on input data to generate accurate output based on domain data. For example, the generative forecast circuit 140 can correspond at least partially in one or more of structure and operation to the system processor 110, or can include one or more processors or portions thereof configured to be compatible with a generative AI model configure to operate on domain data.

The generative action circuit 150 can cause action by or with respect to a computing system of a financial institution, via a generative AI model based on one or more parameters via a generative AI model. Thus, the generative action circuit 150 can execute one or more instructions with respect to a computing system of a financial institution based on domain data, at a speed and accuracy beyond that of manual operation. For example, the generative action circuit 150 can correspond at least partially in one or more of structure and operation to the system processor 110, or can include one or more processors or portions thereof configured to be compatible with a generative AI model configure to operate on domain data.

The client computing system 103 can communicate with the data processing system 102 by the network 101, by one or more communication protocols therebetween. The client computing system 103 can include a user interface 170. The user interface 170 can include a user interface presentable on a display device operatively coupled with or integrated with the client computing system 103. The display can display at least one or more user interface presentations and control affordances, and can include an electronic display. An electronic display can include, for example, a liquid crystal display (LCD), a light-emitting diode (LED) display, an organic light-emitting diode (OLED) display, or the like. The display device can be housed at least partially within the client computing system 103.

For example, the client computing system 103 can be or include a customer device. The customer device is owned, operated, controlled, managed, and/or otherwise associated with a customer (e.g., a customer of the financial institution). While only one customer device 103 is depicted, it is to be appreciated that a plurality of customer computing devices may be included with the system 100. In some embodiments, the customer device 103 may be or may include, for example, a desktop or laptop computer (e.g., a tablet computer), a smartphone, a wearable device (e.g., a smartwatch), a personal digital assistant, and/or any other suitable computing device. In the example shown, the customer device is structured as a mobile computing device, namely a smartphone.

In some embodiments, the customer device includes one or more I/O devices, a network interface circuit, and one or more customer client applications. While the term “I/O” is used, it should be understood that the I/O devices may be input-only devices, output-only devices, and/or a combination of input and output devices. In some instances, the I/O devices include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices further include one or more user interfaces (devices or components that interface with the customer), which may include one or more biometric sensors (such as a fingerprint reader, a heart monitor that detects cardiovascular signals, face scanner, an iris scanner, etc.).

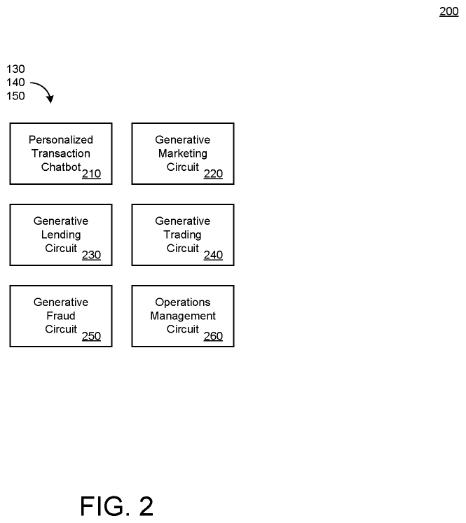

FIG. 2 depicts an example generative engine computing system, in accordance with present implementations. As illustrated by way of example in FIG. 2, an example generative engine 200 can include at least a personalized transaction chatbot 210, a generative marketing circuit 220, a generative lending circuit 230, a generative trading circuit 240, a generative fraud circuit 250, and an operations management circuit 260.

The personalized transaction chatbot 210 can utilize AI to support or augment intelligent chatbot functionality in servicing. For example, the personalized transaction chatbot 210 can correspond to a computing device or a processor having a structure configured to execute instructions corresponding to the operations discussed herein. For example, the personalized transaction chatbot 210 can correspond to one or more instructions stored at the system memory 160 and executable by the system processor 110.

At least one aspect can be directed to forecast models/recommendations. For example, the personalized transaction chatbot 210 can use proprietary bank data on and/or regarding an individual or entity, including market conditions relevant to the bank data or the individual or entity. The personalized transaction chatbot 210 can execute or provide, via generative AI, future scenarios based on the proprietary bank data or other financial data or financial parameters as discussed herein. For example, a generative AI can correspond to or include an artificial intelligence (AI) model or multimodal model (MMM). For example, the generative AI can be linked with decision logic corresponding to if/then statement pivots within each model for varying/different forecast models for an individual/family/small business/commercial customer/corporate client. To that extent, the LLM or MMM can be specific to an individual user in certain situations. For example, a customer's individual data can be used to train a customer-specific LLM or NMM to provide customer specific responses to that customer's query. The customer-specific LLM or MMM may be configured to only respond to inquiries from the corresponding customer to keep that customer's individual information private. For example, the personalized transaction chatbot 210 can provide specific recommendations based upon the context with background/tradeoffs/risks and share the logic used to make the recommendation.

The personalized transaction chatbot 210 can provide responses to specific inquiries relevant to proprietary bank or financial data. For example, a system can train an LLM or MMM with proprietary commercial/corporate bank data to answer specific quantitative and qualitative inquiries. For example, a question can include, “Will this check be able to clear on this day given the projected available balance?” In response the personalized transaction chatbot 210 can provide a response including various scenarios with quantitative assessment of risk tolerances/probabilities and different actions to reduce risk, based on the proprietary data, the financial parameters, or both. The personalized transaction chatbot 210 can learn about a person or entity via generative AI, including financial parameters linked with or associated with that individual or entity. The personalized transaction chatbot 210 can, based on the learned parameters, predict a type of messaging or service that would be most effective for a context. For example, a context can correspond to a particular financial transaction related to a particular individual or entity.

As discussed herein, an LLM can refer to an AI model configured to receive as input one or more text prompts or input corresponding to text, and to generate output corresponding to text. For example, an AI model can correspond to an LLM configured to receive as input a prompt including first text and to generate output including second text that corresponds to an action object. Here, an action object can correspond to, but is not limited to, a text object including a generative text output that indicates or describes an action with respect to account information (e.g., financial account information) of a particular individual user or customer.

As discussed herein, an MMM can refer to an AI model configured to receive as input one or more text prompts or input corresponding to text, or multimedia content, and to generate output corresponding to text or multimedia content. For example, an AI model can correspond to a multi-modal model (MMM) configured to receive as input a prompt including one or more of first text and first multimedia content, and to generate output including one or more of second text and second multimedia content that corresponds to the action object. For example, multimedia content can correspond to one or more of an image, an audio file, a video file, a 3D object, or any combination thereof, or any plurality thereof, but is not limited thereto.

The generative marketing circuit 220 can provide tailored and/or targeted customer acquisition in a digital experience For example, the generative marketing circuit 220 can correspond to a computing device or a processor having a structure configured to execute instructions corresponding to the operations discussed herein. For example, the generative trading circuit 240 can correspond to one or more instructions stored at the system memory 160 and executable by the system processor 110.

At least one aspect can be directed to generative AI configured to generate output corresponding to targeted campaigns and messaging. For example, the generative marketing circuit 220 can train an LLM/MMM model based upon a certain market segment or individual (if available) attributes/behaviors to determine marketing messages/channels/creatives/offers for a given audience. For example, the generative marketing circuit 220 can use a feedback loop into the model with outcomes to fine tune based upon a segment/individual. Channels could include mobile application, podcast, mobile web, in car dash, desktop web, phone voice, voice assistance, e-readers, et al.

At least one aspect can be directed to digital onboarding journey. For example, the generative marketing circuit 220 can leverage an LLM/MMM model to ensure the right type of onboarding journey for each given customer. Some customers may want the most streamlined experience for an app and others may want to opt to read all the fine print and ensure all optional steps remain due to their approach. At least one aspect can be directed to a digital ongoing interaction model. For example, the generative marketing circuit 220 can leverage an LLM/MMM to ensure that onboarding journeys into parallel and expansive products is smooth and efficient for both in house and bundled products with partners. For example, the generative marketing circuit 220 can allow for single click access and activation of these services based upon an AI recommendation, based on one or more parameters as discussed herein. Thus, thus generative marketing circuit 220 can achieve at least the technical improvements of increasing customer satisfaction and engagement on a daily or cumulative basis and to ensure the effective deployment of marketing resources and funds to achieve revenue targets.

The generative lending circuit 230 can leverage generative AI to provide holistic customer modeling and risk based on one or more parameters as discussed herein. For example, the generative lending circuit 230 can correspond to a computing device or a processor having a structure configured to execute instructions corresponding to the operations discussed herein. For example, the generative trading circuit 240 can correspond to one or more instructions stored at the system memory 160 and executable by the system processor 110.

At least one aspect can be directed to portfolio wide risk assessment. For example, the generative lending circuit 230 can leverage an LLM/MMM model to ingest data about a bank's overall portfolio of loans and to then make judgments on the type of risk it presents, options for how to adjust and tradeoffs, based on one or more parameters as discussed herein. Include this portfolio wide assessment as a factor/consideration for how it would be impacted for each new loan that comes on to the balance sheet.

At least one aspect can be directed to alternative scoring models. For example, the generative lending circuit 230 can leverage an LLM/MMM to ingest extrinsic data about a customer to generate a more robust view of their credit worthiness. For example, based on the parameters and the extrinsic data, the generative lending circuit 230 can generate a score with a 3-dimensional verbal view of the risks/tradeoffs of moving forward with a new liquidity product for this customer. For example, a single LLM or MMM can support individual or entities of multiple types and number (e.g., individual, family, small business, commercial entity, corporate entity).

At least one aspect can be directed to alternative underwriting models. For example, the generative lending circuit 230 can leverage an LLM/MMM model, based on one or more parameters or extrinsic data, create a tiered underwriting model that would provide the financial institution to set thresholds for automated/pass through approval (low risk/high score/no human) and the opposite side of the continuum (high risk/low score) routing to a human team to assess and determine how to best proceed.

The generative trading circuit 240 can provide at least predictive trading for traders. For example, the generative trading circuit 240 can correspond to a computing device or a processor having a structure configured to execute instructions corresponding to the operations discussed herein. For example, the generative trading circuit 240 can correspond to one or more instructions stored at the system memory 160 and executable by the system processor 110.

At least one aspect can be directed to signals and model training. For example, the generative trading circuit 240 can train an LLM/MMM to optimally trade securities based on one or more parameters or extrinsic data. For example, the generative trading circuit 240 can leverage one or more data sources/signals for the training, including but not limited to, a day of the week relative to earnings, price data, media mentions, social media sentiment one or more platforms, on a rolling time frame. The generative trading circuit 240 can leverage signals in aggregate to create thematic trends as foundations for the trading recommendation (e.g., buy, sell, short, call, put, leverage, or cash position risk). The generative trading circuit 240 can formulate trade recommendations and thresholds for automatic execution vs human review and approval workflow. The generative trading circuit 240 can route instructions to generate user interfaces at devices linked with decisionmakers for a particular transaction, based upon the type of trade and collect feedback to execute or decline the transaction. The generative trading circuit 240 can provide a high frequency trading analysis circuit, ensure to account for high frequency trading impact and integrate in the time for trade to execution for each of your trading locations. The generative trading circuit 240 can identify out of band losses in real time and/or warn of them before they occur to the right people at the right time to minimize unseen downside risk and to ensure action.

The generative fraud circuit 250 can provide at least fraud prevention, identification and recovery. For example, the generative fraud circuit 250 can correspond to a computing device or a processor having a structure configured to execute instructions corresponding to the operations discussed herein. For example, the operations management circuit 260 can correspond to one or more instructions stored at the system memory 160 and executable by the system processor 110.

In some embodiments, the generative fraud circuit 250 can create a parallel set of data based upon real data in order to train a model and to fine tune it without needing certain data (e.g., the actual PII or restricted information). The generative fraud circuit 250 can perform signals and model training. For example, the generative fraud circuit 250 can train an LLM/MMM to ingest synthetic or real data as discussed herein, and signals to identify potential fraudulent transaction before they are executed. The generative fraud circuit 250 can involve an extra step or stop the transaction real time. Alternatively, once fraud is reported, the generative fraud circuit 250 can train the model to automatically adjust to reduce risk for the customer on a going-forward basis. At least one aspect can be directed to workflow creation. For example, the generative fraud circuit 250 can leverage a generative AI model, including one or more parameters or extrinsic data, to automatically stop certain transactions based upon risk thresholds and flag others for further investigation.

The operations management circuit 260 can provide at least output based on one or more parameters or extrinsic data in the human resources domain. For example, the operations management circuit 260 can correspond to a computing device or a processor having a structure configured to execute instructions corresponding to the operations discussed herein. For example, the operations management circuit 260 can correspond to one or more instructions stored at the system memory 160 and executable by the system processor 110.

At least one aspect can be directed to recruiting and interviewing. For example, the operations management circuit 260 can build and train an LLM/MMM on a pool of potential recruits for a potential job offer to identify the best way to identify, evaluate, generate meeting requests and confirm workflow for interviews. For example, the operations management circuit 260 can leverage social media, resumes, other job postings, workflow calendar availability and confirmation data regarding interviews. At least one aspect can be directed to employee onboarding and training, including contextualized onboarding and training for a new employee based upon role description, location, market conditions/urgency. At least one aspect can be directed to HR, finance, virtual assistant models, and employee servicing, including AI Tools that can help the efficiency for FTEs.

For example, the system 102 can obtain, based on the query, an entity parameter corresponding to the one or more aspects extrinsic to the entity and linked with the entity. The system 102 can generate, via the AI model, the entity object, the AI model receiving as input the entity parameter. For example, the system 102 can include the entity parameter indicating an audience of output of the AI model, the audience based at least partially on the one or more aspects extrinsic to the entity and linked with the entity. For example, the system 102 can obtain, based on the query, a condition parameter corresponding to the one or more aspects extrinsic to the object and the entity. The system 102 can generate, via the AI model, the condition object, the AI model receiving as input the condition parameter.

For example, the system 102 can generate, via the AI model, a plurality of action objects can include the action object, each of the plurality of action objects identifying corresponding action metrics can include the action metric. For example, the system 102 can include the plurality of action objects each corresponding to respective text objects generated by the AI model, each of the text objects can include respective descriptions of respective aspects of respective actions can include the transaction in view of respective action metrics for each of the text objects. For example, the system 102 can include the corresponding action metrics each linked with one or more corresponding thresholds that respectively indicate one or more respective conditions for execution of the transaction.

For example, the system 102 can obtain, via the AI model, a text prompt corresponding to the query that identifies the object and the entity. For example, the system 102 can include the entity corresponding to one or more of an individual, a plurality of individuals, a private corporation, and a public corporation, and the AI model configured to obtain the entity object corresponding to one or more of the individual, the plurality of individuals, the private corporation, and the public corporation. For example, the system 102 can include the entity corresponding to one or more of an unbanked entity, a banked entity, or a high net worth entity, and the AI model configured to obtain the entity object corresponding to one or more of the unbanked entity, the banked entity, or the high net worth entity. For example, the system 102 can include the object corresponding to a financial asset, financial lability, financial model, or an identifier thereof.

For example, the system 102 can include the entity object corresponding to a text object generated by the AI model and can include a description of the entity, the description based on the entity and the one or more aspects extrinsic to the entity and linked with the entity. For example, the system 102 can include the condition object corresponding to a text object generated by the AI model and can include a description of the one or more aspects extrinsic to the object and the entity. For example, the system 102 can include the action object corresponding to a text object generated by the AI model and can include a description of one or more aspects of an action can include the transaction in view of the action metric.

For example, the system 102 can cause a user interface to present one or more of the entity object, the condition object, and the action object. For example, the system 102 can obtain, via a user interface, a selection of the action object. For example, the system 102 can include the actual transactions corresponding to transactions that have been executed by one or more entities. For example, the system 102 can include the synthetic transactions (e.g., synthetic financial transactions) corresponding to transactions (e.g., financial transactions) that have not been executed by one or more entities.

For example, the system 102 can cause, in response to a determination that an authenticity metric satisfies a fraud threshold corresponding to an entity among the one or more entities, execution of a transaction that can include the entity and an object corresponding to the entity. For example, the system 102 can identify, based on a query, the entity and the object. The system 102 can obtain, via the AI model, an entity object that identifies one or more aspects extrinsic to the entity and linked with the entity. For example, the system 102 can cause a user interface to present the entity object. the system 102 can generate the authenticity metric based on the entity object and one or more of the synthetic transactions. For example, the system 102 can generate, via the AI model, an action object that identifies an action metric, the AI model receiving as input the synthetic transactions and the entity object. For example, the system 102 can obtain, via a user interface, a selection of the action object.

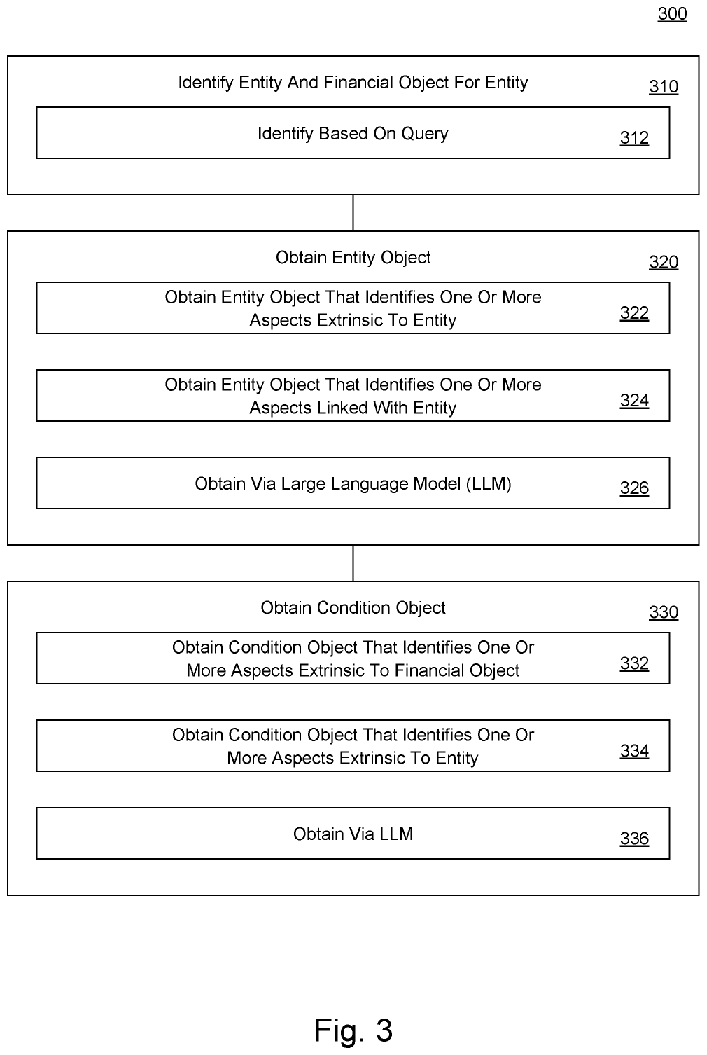

FIG. 3 depicts an example method of operating a generative AI architecture with domain optimization, in accordance with present implementations. At least the system 100 or the circuit 200, or any component thereof, can perform method 300.

At process 310, the method 300 includes identifying an entity and an object for the entity. At process 312, the method 300 includes identifying an entity and an object for the entity based on a query. For example, the method can include obtaining, via the AI model, a text prompt corresponding to the query that identifies the object and the entity. For example, the method can include the entity object corresponding to a text object generated by the AI model and can include a description of the entity, the description based on the entity and the one or more aspects extrinsic to the entity and linked with the entity. For example, the method can cause a user interface to present the entity object.

At process 320, the method 300 includes obtaining an entity object. For example, the method can include obtaining, based on the query, an entity parameter corresponding to the one or more aspects extrinsic to the entity and linked with the entity. The method can include generating, via the AI model, the entity object, the AI model receiving as input the entity parameter. For example, an entity parameter can correspond to extrinsic data or a parameter as discussed herein. For example, the method can include the entity parameter indicating an audience of output of the AI model, the audience based at least partially on the one or more aspects extrinsic to the entity and linked with the entity. For example, an audience can indicate a role of the entity linked with a language parameter. For example, an entity can correspond to a CFO, and a language parameter can be configured to output via the generative AI a text object written in a tone for consumption by a CFO, based on the language parameter, and a parameter.

At process 322, the method 300 includes obtaining an entity object that identifies one or more aspects extrinsic to the entity. For example, aspects extrinsic to the entity can correspond to extrinsic data. At process 324, the method 300 includes obtaining an entity object that identifies one or more aspects linked with the entity. At process 326, the method 300 includes obtaining an entity object via an LLM. For example, the data process system 102 can identify, based on a query, the entity and the object. The method can include obtaining, via the AI model, an entity object that identifies one or more aspects extrinsic to the entity and linked with the entity.

At process 330, the method 300 includes obtaining a condition object. For example, a condition object can correspond to a metric or a plurality of metrics bounding a scenario based on a parameter, transaction, or a financial analysis, but is not limited thereto. For example, the scenario can correspond to credit metrics or ranges, financial conditions of an entity over time, or market conditions over time, but is not limited thereto. For example, the method can include the condition object corresponding to a text object generated by the AI model and can include a description of the one or more aspects extrinsic to the object and the entity. At process 332, the method 300 includes obtaining a condition object that identifies one or more aspects extrinsic to the object. At process 334, the method 300 includes obtaining a condition object that identifies one or more aspects extrinsic to the entity. At process 336, the method 300 includes obtaining the condition object via the AI model. For example, the method can include obtaining, based on the query, a condition parameter corresponding to the one or more aspects extrinsic to the object and the entity. The method can include generating, via the AI model, the condition object, the AI model receiving as input the condition parameter. For example, the condition parameter can correspond to an income parameter in a query, including, “generate a mortgage refinance forecast based on a 10% increase in my income in 5 years.”

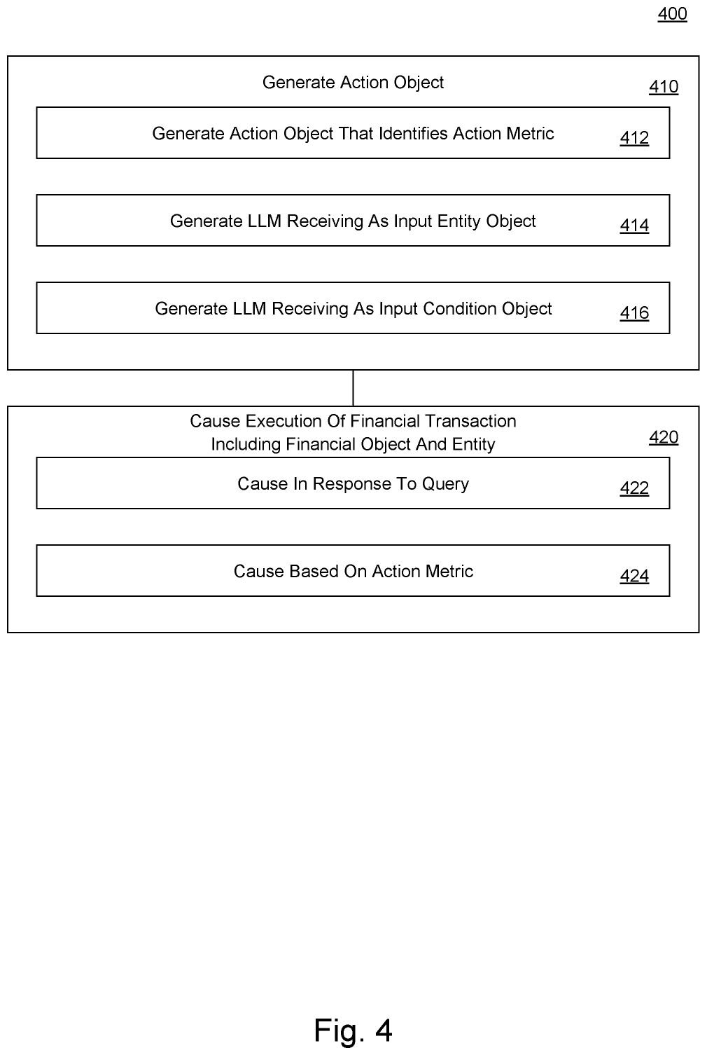

FIG. 4 depicts an example method of operating a generative AI architecture with domain optimization, in accordance with present implementations. At least the system 100 or the circuit 200, or any component thereof, can perform method 400.

At 410, the method 400 can generate an action object. For example, an action object can correspond to one or more instructions compatible with a computing system of a financial institution to execute, block, defer, modify, or aggregate one or more financial transactions based on one or more financial parameters as discussed herein. At 412, the method 400 can generate an action object that identifies an action metric. For example, an action metric can correspond to a parameter corresponding to an entity, an account, or a transaction, to execute, block, defer, modify, or aggregate one or more transactions. For example, the method can include generating, via the AI model, a plurality of action objects can include the action object, each of the plurality of action objects identifying corresponding action metrics. For example, the method can include the plurality of action objects each corresponding to respective text objects generated by the AI model, each of the text objects can include respective descriptions of respective aspects of respective actions can include the transaction in view of respective action metrics for each of the text objects. At 414, the method 400 can generate the AI model receiving as input the entity object. At 416, the method 400 can generate the AI model receiving as input the condition object. For example, the method can include the corresponding action metrics each linked with one or more corresponding thresholds that respectively indicate one or more respective conditions for execution of the transaction.

For example, the method can include the action object corresponding to a text object generated by the AI model and can include a description of one or more aspects of an action can include the transaction in view of the action metric. For example, the method can include the entity corresponding to one or more of an individual, a plurality of individuals, a private corporation, and a public corporation, and the AI model configured to obtain the entity object corresponding to one or more of the individual, the plurality of individuals, the private corporation, and the public corporation. For example, the method can include the entity corresponding to one or more of an unbanked entity, a banked entity, or a high net worth entity, and the AI model configured to obtain the entity object corresponding to one or more of the unbanked entity, the banked entity, or the high net worth entity. For example, the method can generate the authenticity metric based on the entity object and one or more of the synthetic transactions.

At 420, the method 400 can cause execution of a transaction including the object and the entity. For example, the method can include the object corresponding to a financial asset, financial liability, financial model, or an identifier thereof. For example, the object can correspond to an identifier of, reference to, or container of one or more metrics that individually or collectively define, for example, a financial asset, financial liability, or financial model. At 422, the method 400 can cause in response to the query. For example, the method can include causing a user interface to present one or more of the entity object, the condition object, and the action object. For example, the method can include obtaining, via a user interface, a selection of the action object. At 424, the method 400 can cause based on the action metric. For example, the method can generate, via the AI model, an action object that identifies an action metric, the AI model receiving as input the synthetic transactions and the entity object. For example, the method can obtain, via a user interface, a selection of the action object.

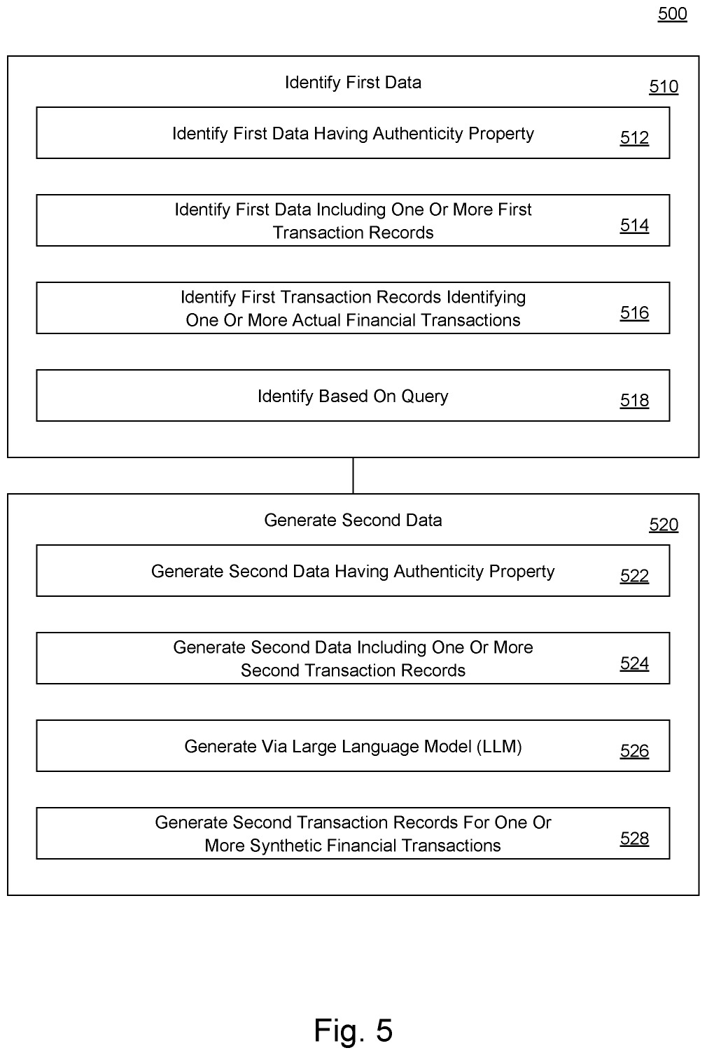

FIG. 5 depicts an example method of operating a generative AI architecture with domain optimization, in accordance with present implementations. At least the system 100 or the circuit 200, or any component thereof, can perform method 500.

At 510, the method 500 can identify first data. For example, first data can correspond to real financial data. At 512, the method 500 can identify first data having an authenticity property. For example, the method can cause, in response to a determination that an authenticity metric satisfies a fraud threshold corresponding to an entity among the one or more entities, execution of a transaction can include the entity and an object corresponding to the entity. At 514, the method 500 can identify first data including one or more first transaction records. At 516, the method 500 can identify the first transaction records identifying one or more actual transactions. At 518, the method 500 can identify based on a query. For example, the method can include the actual transactions corresponding to transactions that have been executed by one or more entities.

At 520, the method 500 can generate second data. For example, second data can correspond to synthetic financial data as discussed herein. At 522, the method 500 can generate second data having the authenticity property. For example, an authenticity property can correspond to an aggregate percentage of fraudulent transactions with respect to valid transaction in the first data and the second data. At 524, the method 500 can generate second data including one or more second transaction records. At 526, the method 500 can generate via an artificial intelligence (AI) model. At 528, the method 500 can generate the second transaction records for one or more synthetic transactions. For example, the method can include the synthetic transactions corresponding to transactions that have not been executed by one or more entities.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system comprising:
one or more memory devices; and
one or more processors coupled to the one or more memory devices, the one or more processors configured to:
identify, based on a query, an entity and an object corresponding to the entity;
obtain, via an artificial intelligence (AI) model, an entity object that identifies one or more aspects extrinsic to the entity and linked with the entity;
obtain, via the AI model, a condition object that identifies one or more aspects extrinsic to the object and the entity;
generate, via the AI model, an action object that identifies an action metric, the AI model receiving as input the entity object and the condition object; and
cause, in response to the query and based on the action metric, execution of a transaction including the object and the entity.

2. The system of claim 1, wherein the one or more processors are further configured to:
obtain, based on the query, an entity parameter corresponding to the one or more aspects extrinsic to the entity and linked with the entity; and
generate, via the AI model, the entity object, the AI model receiving as input the entity parameter,
wherein the entity parameter indicates an audience of output of the AI model, the audience based at least partially on the one or more aspects extrinsic to the entity and linked with the entity.

3. The system of claim 1, wherein the one or more processors are further configured to:
obtain, based on the query, a condition parameter corresponding to the one or more aspects extrinsic to the object and the entity;
generate, via the AI model, the condition object, the AI model receiving as input the condition parameter; and
generate, via the AI model, a plurality of action objects including the action object, each of the plurality of action objects identifying corresponding action metrics including the action metric,
wherein the plurality of action objects each correspond to respective text objects generated by the AI model, each of the text objects including respective descriptions of respective aspects of respective actions including the transaction in view of respective action metrics for each of the text objects.

4. The system of claim 3, wherein the corresponding action metrics are each linked with one or more corresponding thresholds that respectively indicate one or more respective conditions for execution of the transaction.

5. The system of claim 1, wherein the entity corresponds to one or more of a private corporation, a public corporation, an unbanked entity or person, or a banked entity or person, and wherein the AI model is configured to obtain the entity object corresponding to one or more of the private corporation, the public corporation, the unbanked entity or person, or the banked entity or person.

6. The system of claim 1, wherein the object is a financial object, and wherein the financial object corresponds to a financial asset, a financial lability, or a financial model.

7. The system of claim 1, wherein the entity object corresponds to a text object generated by the AI model and includes a description of the entity, wherein the description is based on the entity and the one or more aspects extrinsic to the entity and linked with the entity.

8. The system of claim 1, wherein the condition object corresponds to a text object generated by the AI model and includes a description of the one or more aspects extrinsic to the object and the entity, and wherein the action object corresponds to a text object generated by the AI model and includes a description of one or more aspects of an action including the transaction in view of the action metric.

9. A system comprising:
at least one processing circuit comprising at least one memory coupled to at least one processor, the at least one processing circuit configured to:
identify, based on a query, first data having an authenticity property and including one or more first transaction records, the first transaction records identifying one or more actual transactions; and
generate, via an artificial intelligence (AI) model, second data having the authenticity property and including one or more second transaction records, the second transaction records corresponding to one or more synthetic transactions that have not been executed by the one or more entities.

10. The system of claim 9, wherein the one or more actual transactions correspond to one or more transactions that have been executed by one or more entities.

11. The system of claim 9, wherein the one or more synthetic transactions correspond to one or more transactions that have not been executed by one or more entities.

12. The system of claim 9, wherein the at least one processing circuit is configured to:
cause, in response to a determination that an authenticity metric satisfies a fraud threshold corresponding to an entity among the one or more entities, execution of a transaction including the entity and an object corresponding to the entity.

13. The system of claim 12, wherein the at least one processing circuit is further configured to:
identify, based on a query, the entity and the object; and
obtain, via the AI model, an entity object that identifies one or more aspects extrinsic to the entity and linked with the entity.

14. The system of claim 13, wherein the at least one processing circuit is further configured to:
cause a user interface to present the entity object.

15. The system of claim 12, wherein the at least one processing circuit is further configured to:
generate the authenticity metric based on the entity object and one or more of the synthetic transactions.

16. The system of claim 13, wherein the at least one processing circuit is configured to:
generate, via the AI model, an action object that identifies an action metric, the AI model receiving as input the one or more synthetic transactions and the entity object.

17. The system of claim 16, wherein the at least one processing circuit is configured to:
obtain, via a user interface, a selection of the action object.

18. A method, comprising:
identifying, based on a query, first data having an authenticity property and including one or more first transaction records, the one or more first transaction records identifying one or more actual transactions; and
generating, via an artificial intelligence (AI) model, second data having the authenticity property and including one or more second transaction records, the one or more second transaction records corresponding to one or more synthetic transactions that have not been executed by the one or more entities.

19. The method of claim 18, wherein the AI model corresponds to a large language model (LLM) configured to receive as input a prompt including first text and to generate an output including a second text that corresponds to the action object.

20. The method of claim 18, wherein the AI model corresponds to a multi-modal model (MMM) configured to receive as input a prompt including one or more of first text or first multimedia content, and generates an output including one or more of second text or second multimedia content that corresponds to the action object.
